(19) United States
(12) Patent Application Publication
(10) Pub. No.: US 2018/0268965 A1
(43) Pub. Date: Sep. 20, 2018

(54) DATA CABLE FOR HIGH SPEED DATA TRANSMISSIONS AND METHOD OF MANUFACTURING THE DATA CABLE

(71) Applicant: LEONI KABEL GMBH, Nuernberg (DE)

(72) Inventors: MELANIE DETTMER, HEEDE (DE); BERND JANSSEN, FRIESOYTHE OT NEUSCHARREL (DE); FRANK JAKOBS, BREMEN (DE)

(21) Appl. No.: 15/980,952

(22) Filed: May 16, 2018

Related U.S. Application Data
(63) Continuation of application No. PCT/EP2016/075484, filed on Oct. 24, 2016.

(30) Foreign Application Priority Data
Nov. 17, 2015 (DE) 102015222699.9

(51) Int. Cl. H01B 11/18; H01B 11/00; H01B 7/02; H01B 13/14

(52) U.S. Cl. CPC H01B 11/18; H01B 11/002; H01B 3/441; H01B 7/0275; H01B 13/141; H01B 7/0216

(57) ABSTRACT

A data cable for high-speed data transmissions has a core pair enclosed by a pair shield. The core pair has two conductors each formed by a signal conductor and a conductor insulation surrounding the signal conductor. The conductors of the conductor pair run parallel to one another. An insulating intermediate casing is arranged between the core pair and the pair shield.

### CROSS-REFERENCE TO RELATED APPLICATION

This is a continuation application, under 35 U.S.C. § 120, of copending international application No. PCT/EP2016/075484, filed Oct. 24, 2016, which designated the United States; this application also claims the priority, under 35 U.S.C. § 119, of German patent application No. 10 2015 222 699.9, filed Nov. 17, 2015; the prior applications are herewith incorporated by reference in their entirety.

### BACKGROUND OF THE INVENTION

### Field of the Invention

The invention relates to a data cable for high speed data transmissions having at least one conductor pair composed of two conductors which extend in the longitudinal direction and which are surrounded by a pair shield.

At the time of the application, such a data cable is offered by the applicant under the trademark “PARALINK 23”. Such data cables are used, in particular, for high-speed transmission of signals between computers, for example in computing centers.

In the field of data transmission, for example in computer networks, data cables are used in which typically a plurality of data leads are combined in a common cable sheath. In the case of high speed data transmissions, shielded conductor pairs are respectively used as data lines, wherein the two conductors run, in particular, parallel to one another or are alternatively twisted with one another. Such a conductor is composed here of the actual conductor, for example a solid conductor wire or else a braided wire which is respectively surrounded by insulation. The conductor pair of a respective data line is surrounded by the (pair) shield. The data cables typically have a multiplicity of conductor pairs which are shielded in such a way and which form a line core and which are surrounded by a common outer shield and a common cable sheath. Such data cables are used for high speed data connections and are designed for data rates of higher than 25 Gbit/s at a transmission frequency of higher than 25 GHz. The outer shield is important here for the electromagnetic compatibility (EMC) and for the electromagnetic interference (EMI) with the surroundings. No signals are transmitted via the outer shield. On the other hand, the respective pair shield determines the symmetry and the signal properties of a respective conductor pair. In this context, a high degree of symmetry of the pair shield is important for undisrupted data transmission.

Such data cables are typically so called symmetrical data lines in which the signal is conveyed over the one conductor and the inverted signal is conveyed over the other conductor. The differentiated signal portion between these two signals is evaluated, with the result that external effects which act on both signals are eliminated.

Such data cables are frequently connected in pre assembled form to plugs. In the case of applications for high speed transmissions, the plugs here are frequently embodied as what are referred to as small form pluggable plugs, known as SFP plugs for short. In this context there are different embodiment variants, for example what are referred to as SFP+, CXP or QSFP plugs which, in a configuration of the data cables for 25 Gbit/s, are also referred to as SFP28 or QSFP28. These plugs have special plug housings, such as can be found, for example, in international patent disclosures WO 2011 072 869 A1 or WO 2011 089 003 A1 (corresponding to U.S. Pat. Nos. 8,444,430 and 8,556,646 respectively). A direct, so-called backplane connection without a plug is also alternatively possible.

The pair shield of a respective conductor pair is frequently embodied as a longitudinally folded shield film here, as is apparent, for example, from published European patent application EP 2 112 669 A2, corresponding to U.S. patent publication No. 2009/0260847. The shield film is folded here, running in a longitudinal direction of the cable, about the conductor pair, wherein the outer side regions of the shield film which lie opposite one another overlap in an overlapping region which runs in the longitudinal direction. In order to ensure a defined seat of this longitudinally folded shield film and to avoid buckling thereof in an interstice region between the two conductors, a dielectric intermediate film made of plastic, in particular a polyester film, is wound between the shield film and the conductor pair.

The shield film used for the pair shield is a multilayer pair shield composed of at least one conductive (metal) layer and an insulating carrier layer. Usually an aluminum layer is used as the conductive layer and a PET film is used as the insulating carrier layer. The PET film is configured as a carrier on which the metallic coating is applied in order to form the conducive layer.

In addition to the longitudinally folded shield in the case of pairs extending in parallel, there is basically also the possibility of winding or spinning such as shield film in a helix shape around the conductor pair. However, in the case of relatively high signal frequencies from approximately 15 GHz such spinning of the conductor pair with a shield film is, for reasons of design, not readily possible owing to resonance effects. Therefore, the shield film is frequently preferably applied as a longitudinally folded shield film for these high frequencies.

Published, non-prosecuted German patent application DE 10 2012 204 554 A1, corresponding to U.S. patent publication No. 2015/0008011, discloses signal cable for high frequency signal transmission, in which the signal conductor is embodied as a braided conductor with a varying run length. In addition, the signal cable also has a shielding braid, wherein individual braid strands of the shielding braid are also wound with a varying run length here. The transmission quality is improved by these measures.

Published, non-prosecuted German patent application DE 103 15 609 A1 discloses a data cable for a high frequency data transmission, in which cable a conductive pair is surrounded by a pair shield which is embodied as a shield film. In addition, the intermediate film is also wound around the conductive pair.

### BRIEF SUMMARY OF THE INVENTION

Taking the above as a starting point, the invention is based on the object of specifying a high speed data cable with good transmission properties even at high transmission rates and high transmission frequencies.

This object is achieved according to the invention by a data cable having the features of the independent cable claim and by means of a method for manufacturing such a data cable having the features of the independent method claim.

The data cable is configured for high speed data transmission and has at least one conductor pair composed of two conductors extending in the longitudinal direction. A respective conductor is formed here by a signal conductor and a conductor insulation surrounding the latter. Furthermore, the conductor pair is surrounded by a pair shield which is formed, in particular, by a shield film, wherein an insulating intermediate sheath is arranged between the conductor pair and the pair shield.

In contrast to conventional conductor pairs with a pair shield, such as are known, for example, by the trade name PARALINK 23, in this configuration an intermediate film which is otherwise customary is not arranged between the conductor pair and the pair shield. The intermediate film is instead replaced by the intermediate sheath. The intermediate sheath here is understood to be generally an element which completely surrounds the conductor pair and which is not embodied as a wound or folded film.

This configuration is based, on the one hand, on the idea that such an intermediate layer between the conductor pair and the pair shield is particularly advantageous, in particular in the case of high-speed data transmissions, for example in a frequency range of >10 GHz. In the case of such high speed data transmissions, it is no longer readily possible to wind a shield film around the conductor pair, since such winding around often leads to series resonance owing to the design, which series resonance limits the frequency range for the data transmission, depending on the dimensions. In order to avoid this resonant frequency and therefore to extend the frequency range to, for example, >20 GHz, a longitudinally folded shielding film, in particular an AL PET film, is usually applied. The folding of the film has, however, the disadvantage that very small asymmetries greatly increase the so called mode conversion owing to only low attenuation of the common mode signal, and therefore drops occur in the insertion loss. In order to avoid this, in currently known data lines an intermediate film made of polyester is wound on between the conductor pair and the shield film which is longitudinally folded (also referred to as longitudinally extending). This prevents one side of the longitudinally folded film from penetrating the interstice region of the conductors.

The refinement according to the invention is also based on the idea that such a design with a wound on polyester intermediate film has the disadvantage that polyester is not the first selection for high frequency applications. It is a further disadvantage that the film is very thin compared to the wall thickness of the conductor, as a result of which the signal conductors (usually solid wires) are securely coupled to the shield (pair shield). In such refinements, a negative effect on the frequency response is also due to the fact that the disruptive common mode signal has a higher propagation speed in comparison with the differential mode signal (useful signal) [that is to say VScc21>VSdd21].

These problems are avoided by the inventive replacement of the thin polyester film by the inner sheath. This measure provides, in particular, the following advantages:

a) The insertion loss behavior is improved.
b) The mode conversion is smaller.
c) The propagation speed of the common mode signal is reduced in comparison with the useful signal.
d) As a result of the mechanically more stable sheath in comparison with the thin polyester film, the entire shielded conductor pair is mechanically more stable, which is advantageous, in particular, during the assembly of a cable with a plurality of such shielded conductor pairs. The latter are usually stranded with one another. The data cable is also distinguished by a relatively high level of stability during later laying and handling of the cable.

In one preferred refinement, the intermediate sheath is embodied as an extruded intermediate sheath. During manufacture, the two conductors of the conductor pair are therefore fed together to an extruder, and the intermediate sheath is extruded onto the conductor pair.

The intermediate sheath is preferably extruded onto the conductor pair here in the manner of a hose shaped structure. The interstice region between the two conductors is therefore free of material, similarly to the case with the intermediate film which is conventionally used.

The intermediate sheath is composed here of a material which is suitable for high frequency applications and is composed, in particular, of a solid plastic material. Solid plastic material is understood here to mean that the sheath is composed of the material in a solid way and is not embodied, for example, as a foam plastic or as a plastic with air occlusions. Such a plastic which is foamed or provided with air occlusions, in particular referred to as a so-called cellular plastic, is preferably used in fact for the respective conductor insulation of the respective conductor.

Optionally PE, PP, FEP, PTFE or PFA is used here as the material for the intermediate sheath. PE is preferably used.

The intermediate sheath also preferably has a wall thickness in the range from 0.1 mm to 0.35 mm, and, in particular, of approximately 0.2 mm.

A particular advantage of this wall thickness which is thick in comparison with conventional thin polyester films (conventional thicknesses of the previously used films are only 10 μm to 15 μm, for example) is, in particular, also to be considered the improved mechanical stability. At the same time, this measure can reduce the wall thickness of the conductor insulation, as a result of which the individual signal conductors move closer to one another. Furthermore, the distance between the signal conductors and the shield increases. Overall, as a result the signal conductors are coupled more firmly to one another, since the pair shield is located further away from the signal conductors compared to the distance between the signal conductors. Asymmetries therefore have fewer effects, improving the mode conversion performance. Simulations have also shown that with this geometry (signal conductors are closer to one another under the pair shield) the insertion loss is greatly improved.

The wall thickness preferably depends here on the diameter of the respective signal conductors. In fact, the wall thickness of the intermediate sheath increases as the diameter of the signal conductors increases. The diameter of the signal conductors is generally preferably in the range between 0.2 mm and 0.6 mm.

The ratio of the wall thickness to the diameter of the signal conductor is generally approximately in the range from 0.4 to 0.6.

Expediently, the conductor diameter of a respective conductor also varies correspondingly, wherein the conductor diameter lies here in the range between 0.5 mm and 1.2 mm. It is also the case here that the conductor diameter increases as the diameter of the signal conductors increases. The conductor diameter lies here, in particular, in the range of 2-2.5 times the diameter of the signal conductor. For small signal conductors with a diameter in the region of 0.2 mm, on the one hand the conductor diameter is therefore also in the lower range of, for example, 0.5 mm, and the wall thickness of the intermediate sheath is in the region of approximately 0.1 mm. On the other hand, for the upper range of the diameter of the signal conductors of, for example, 0.6 mm, the conductor diameter is preferably also in the upper range, at approximately 1.2 mm, and the wall thickness of the intermediate sheath is approximately 0.35 mm.

The conductor insulation is also expediently composed of a cellular plastic, wherein the cellular plastic preferably has a gas portion in the range of 20% by volume—50% by volume or up to 60% by volume here. In particular PE, PP, FEP or ePTFE is used as the material for the cellular plastic here. With such a design with conductor insulation composed of cellular plastic and at the same time a solid intermediate sheath the particular advantage is obtained that the field of the differential useful signal propagates mainly in the highly cellular material between the conductors, while on the other hand the field of the common mode signal must propagate through the inner sheath with the solid material. As a result, the propagation speed of the common mode signal is particularly advantageously braked, with the result that VScc21<VSdd21, i.e. the propagation speed of the undesired common mode signal is less than the useful signal.

The shielded conductor pair comprises, in particular, conductors which extend in parallel to one another, that is to say are not stranded with one another. Furthermore, the pair shield is preferably a longitudinally folded shield film, in particular a metal lined plastic film (AL PET). The pair shield is formed, in particular, by this metal lined plastic film.

In order to form the data cable, one and preferably a plurality of shielded conductor pairs are connected to one another to form a common cable core. This cable core is surrounded here by a common cable sheath. The cable core is expediently firstly also surrounded by an overall shield which is then surrounded by the cable sheath. In particular, the plurality of shielded conductor pairs are stranded with one another, with the result that the cable core is formed by a stranded composite of a plurality of shielded conductor pairs.

Other features which are considered as characteristic for the invention are set forth in the appended claims.

Although the invention is illustrated and described herein as embodied in a data cable for high speed data transmissions, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE SEVERAL VIEWS OF THE DRAWING

FIG. 1 is a diagrammatic, cross sectional illustration of a shielded conductor pair, and

FIG. 2 is a cross sectional illustration of a data cable with a plurality of such conductor pairs.

### DETAILED DESCRIPTION OF THE INVENTION

Identically acting parts are respectively provided with the same reference symbols in the figures.

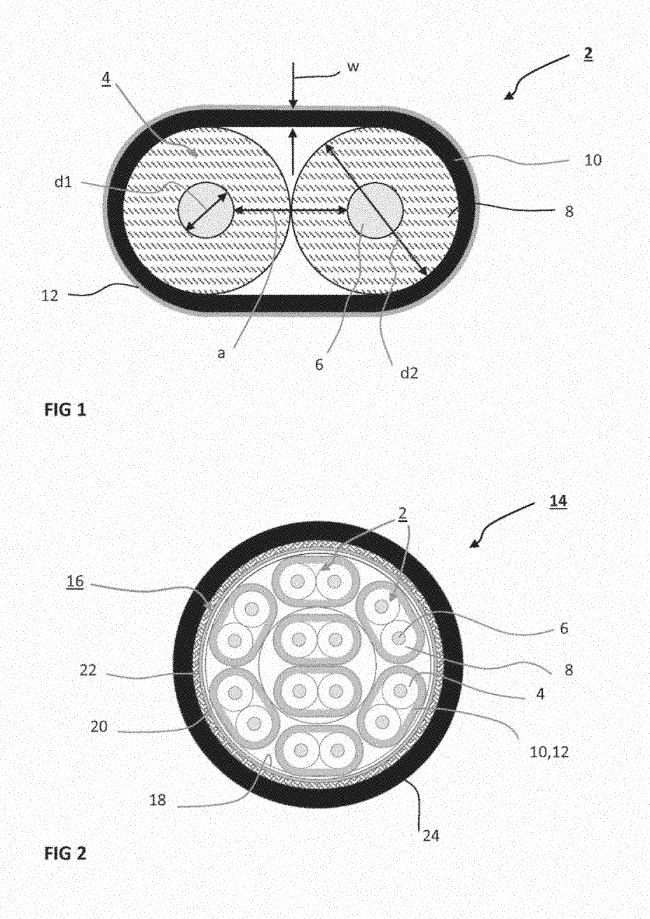

Referring now to the figures of the drawings in detail and first, particularly to FIG. 1 thereof, there is shown A shielded conductor pair 2 that has two conductors 4. These are each formed by a central signal conductor 6 and a conductor insulation 8 surrounding the latter. The signal conductor 6 is preferably formed by a solid wire, in particular silver coated copper wire. It has a diameter d1. The latter is, for example, 0.4 mm in the present case. The conductor 4 has a conductor diameter d2, which is approximately 1.0 mm, that is to say approximately 2.5 times the diameter d1 of the signal conductor 6, in the exemplary embodiment.

The conductor insulation is composed here of a so called cellular plastic which therefore has, in contrast with a solid material, a comparatively high gas portion in the region of 20% by volume. The two conductors 4 bear directly one against the other and are in contact. The distance between the two conductors “a” therefore corresponds to twice the value of the thickness of the conductor insulation 8 and is therefore 0.6 mm here.

The two conductors 4 are, in particular, surrounded directly by an intermediate sheath 10. The latter is preferably composed of a solid plastic material, that is to say, in contrast to the conductor insulation, is not composed of a cellular plastic or of other foamed or expanded plastic. It is embodied as an extruded sheath, that is to say is applied to the two conductors 4 by an extrusion process. The intermediate sheath 10 is here a hose shaped structure which therefore has a constant wall thickness w circumferentially, and around the two conductors 4. Free interstice regions, in which there is no plastic material, are therefore formed between the two conductors 4 within the intermediate sheath 10.

The wall thickness w of the intermediate sheath is approximately 0.2 mm in the selected exemplary embodiment.

The intermediate sheath 10 is surrounded in turn by a shield film 12, which bears directly on the intermediate sheath 10 and forms a pair shield. The shield film 12 is preferably embodied as a longitudinally folded shield film 12 and is therefore not wound. The shield film 12 is preferably a conventional shield film, specifically an aluminium lined (plastic) film. The latter typically has a film thickness of typically several 10 μm to several 100 μm. The shield film 10 can be a single layer or double layer shield film (metal coating applied to only one side or both sides of the carrier foil). The shielded conductor pair 2 which is illustrated in FIG. 1 is expediently formed exclusively by the elements illustrated in FIG. 1. Therefore, no filler wire is provided. As an alternative to this, such a filler wire can be arranged. In such a case it forms contact with the electrically conductive layer of the shield film 12. Such a filler wire can be provided running, for example, between the intermediate sheath 10 and the shield film 12 or else on the outside of the shield film 12. The filler wire serves to form electrical contact with the shield film 12 in a plug connecting region.

In particular, an otherwise customary intermediate film which is wound around the two conductors 4 is dispensed with. The intermediate film is replaced by the extruded intermediate sheath 10 with the comparatively large wall thickness w compared to conventional shielded conductor pairs. A particular advantage here is the fact that the distance between the signal conductor 6 and the shield film 12 is, as it were, increased and therefore the two signal conductors 6 move closer together, considered in relative terms. Compared to conventional shielded conductor pairs 2, the distance a is therefore reduced. Overall, this also reduces the length to width ratio, with the result that overall the shielded conductor pair 2 is rounded in comparison with conventional shielded conductor pairs. This is advantageous for later assembly.

As a result of the comparatively large intermediate sheath, it is therefore possible overall to reduce the thickness of the conductor insulation 8 while maintaining the distance between the signal conductor 6 and the shield film 12. Overall, this gives rise to relatively thin conductors 4 and correspondingly also to the reduced distance a between the two signal conductors 6. Owing to this reduced distance a, the two conductors 4 are overall coupled more firmly to one another, since the pair shield which is formed by the shield film 12 is now further away from the respective signal conductor 6 compared to the distance a between the signal conductors 6. Undesired asymmetries, which cannot be completely avoided during manufacture, therefore have fewer effects overall. The so called mode conversion performance is significantly improved as a result. The short distance a also improves the insertion loss compared to conventional shielded conductor pairs. Investigations have shown an improvement by 15%.

Finally, it is also to be noted that the electrical field of the differential useful signal is located and propagates predominantly in the (highly cellular) material of the conductor insulation 8, that is to say between the signal conductors 6. On the other hand, the field of the undesired common mode signal has to propagate through the intermediate sheath 10 which is composed of solid material. Overall, this slows down the propagation speed of the undesired common mode signal in comparison with that of the differential useful signal. The common mode signal is therefore not superimposed, or at least no longer to such a large degree, on the useful signal at the end of a transmission link, with the result that better evaluation of the differential useful signal is made possible.

Overall, a differential data signal with high data rates of, for example, >25 Gbit/second can be transmitted at transmission frequencies of >25 GHz in a reliable and safe fashion via the conductor pair 2.

FIG. 2 also shows a possible configuration of a data cable 14 in which a plurality of conductor pairs 2 which are shielded in such a way are combined with one another. Basically, the data cable 14 can also have just one shielded conductor pair 2. The data cable 14 preferably has two, four, sixteen or, as illustrated in FIG. 2, eight shielded conductor pairs 2. The individual conductor pairs 2 are usually stranded with one another here and form a transmission core. In the exemplary embodiment, two internal conductor pairs 2 are stranded with one another and form an inner transmission core. Six further shielded conductor pairs 2 are arranged, in particular, stranded, around the latter. The conductor pairs 2 form here, as it were, an external (cable) layer. The transmission core which is formed by the shielded conductor pairs 2 is surrounded by an overall shield 16. In the exemplary embodiment, an intermediate film 18 composed of plastic is arranged between the transmission core and the overall shield 16. The overall shield 16 can have a customary design. The overall shield 16 is formed here by an inner shield film 20 and an outer shield mesh 22. Other combinations of shield films 20 with C, D shields or with a plurality of shield films etc., are basically possible. Finally, an outer cable sheath 24 for protecting against environmental influences is applied around the overall shield 16. This cable sheath 24 is, in particular, also extruded.

1. A data cable for high speed data transmission, comprising:
at least one conductor pair having two conductors each formed by a signal conductor and a conductor insulation surrounding said signal conductor, said conductors of said conductor pair running parallel to one another;
a pair shield surrounding said conductor pair; and
an insulating intermediate sheath disposed between said conductor pair and pair shield.

2. The data cable according to claim 1, wherein said insulating intermediate sheath is extruded.

3. The data cable according to claim 1, wherein said insulating intermediate sheath is formed in a hose shape.

4. The data cable according to claim 1, wherein said insulating intermediate sheath is composed of a material which is suitable for RF applications and is composed of a solid plastic material.

5. The data cable according to claim 1, wherein said insulating intermediate sheath is formed from a material selected from the group consisting of polyethylene (PE), polypropylene (PP), fluoroethylene propylene (FEP), polytetrafluoroethylene (PTFE) and perfluoroalkoxylalkane (PFA).

6. The data cable according to claim 1, wherein said insulating intermediate sheath has a wall thickness in a range from 0.1 mm to 0.35 mm.

7. The data cable according to claim 1, wherein said signal conductor has a diameter in a range from 0.2 mm to 0.6 mm.

8. The data cable according to claim 6, wherein said wall thickness of said insulating intermediate sheath increases as a diameter of said signal conductor increases, and a ratio of the wall thickness of said insulating intermediate sheath to the diameter of said signal conductor is approximately in a range from 0.4 to 0.6.

9. The data cable according to claim 1, wherein each of said conductors has a conductor diameter which is in a range from 0.4 mm to 1.3 mm, wherein the conductor diameter increases as a signal conductor diameter of said signal conductor increases, and the signal conductor diameter of said signal conductor is in a range between 0.2 mm and 0.6 mm.

10. The data cable according to claim 1, wherein said conductor insulation (8) is composed of a cellular plastic selected from the group consisting of polyethylene (PE), polypropylene (PP), fluoroethylene propylene (FEP) and expanded polytetrafluoroethylene (ePTFE), said cellular plastic has a gas portion of 20-60% by vol.

11. The data cable according to claim 1, wherein said conductor pair is not covered by an insulation film.

12. The data cable according to claim 1, wherein said pair shield has a longitudinally folded shield film.

13. The data cable according to claim 1,
wherein said conductor pair is one of a plurality of conductor pairs, each having said pair shield; and
a cable sheath surrounding said plurality of conductor pairs.

14. The data cable according to claim 1,
wherein the data cable is configured for high speed data transmissions with a data rate of higher than or equal to 25 Gbit/s;
wherein said conductor pair is one of a plurality of conductor pairs which have said pair shield that are stranded with one another,
wherein said conductor insulation is composed of a cellular plastic, said cellular plastic has a gas proportion of 20-60% by vol;
wherein said insulating intermediate sheath is directly extruded on, is in a hose shape and is composed of solid material and has a wall thickness in a range from 0.1 mm to 0.35 mm;
wherein said pair shield is a longitudinally folded shield film bearing directly against said insulating intermediate sheath;
further comprising an overall shield surrounding said conductor pairs which are stranded to one another and are provided with said pair shield; and
further comprising a cable sheath surrounding said overall shield.

15. The data cable according to claim 1, wherein said insulating intermediate sheath has a wall thickness of approximately 0.2 mm.

16. The data cable according to claim 1, wherein said pair shield has a longitudinally folded shield film being a metal lined plastic film,

17. The data cable according to claim 13, further comprising an overall shield disposed between said plurality of conductor pairs and said cable sheath.

18. A method for manufacturing a data cable, which comprises the steps of:
surrounding two conductors with an insulating intermediate sheath; and
subsequently applying a pair shield to the insulating intermediate sheath.
